(19) United States
(12) Patent Application Publication
(10) Pub. No.: US 2022/0405606 A1
(43) Pub. Date: Dec. 22, 2022

(54) INTEGRATION DEVICE, TRAINING DEVICE, AND INTEGRATION METHOD

(71) Applicant: Hitachi, Ltd., Tokyo (JP)

(72) Inventors: Mayumi SUZUKI, Tokyo (JP); Hanae YOSHIDA, Tokyo (JP); Yun LI, Tokyo (JP)

(21) Appl. No.: 17/836,980

(22) Filed: Jun. 9, 2022

(30) Foreign Application Priority Data
Jun. 16, 2021 (JP) 2021-100197

(51) Int. Cl. G06N 5/02

(52) U.S. Cl. CPC G06N 5/022

(57) ABSTRACT

An integration device performs a reception process of receiving a knowledge coefficient relating to first training data in a first prediction model of a first training device from the first training device, a transmission process of transmitting the first prediction model and data relating to the knowledge coefficients of the first training data received in the reception process respectively to a plurality of second training devices, and an integration process of generating an integrated prediction model by integrating a model parameter in a second prediction model generated by training the first prediction model with second training data and the data relating to the knowledge coefficients respectively by the plurality of second training devices, as a result of transmission in the transmission process

### CLAIM OF PRIORITY

The present application claims priority from Japanese patent application JP 2021-100197 filed on Jun. 16, 2021, the content of which is hereby incorporated by reference into this application.

### BACKGROUND OF THE INVENTION

### 1. Field of the Invention

The present invention relates to an integration device, a training device, and an integration method.

### 2. Description of Related Art

Machine learning is one of the technologies that realize Artificial Intelligence (AI). The machine learning technologies are configured with a training process and a prediction process. First, the training process calculates learning parameters so that an error between the predicted value obtained from the input feature amount vector and the actual value (true value) is minimized. Subsequently, the prediction process calculates a new predicted value from data not used for learning (hereinafter referred to as test data).

So far, learning parameter calculation methods and arithmetic operation methods that maximize prediction accuracies of predicted values are devised. For example, a method called a perceptron outputs a predicted value based on the input feature amount vector and an arithmetic result of a linear combination of weight vectors. Neural networks are also known as multi-perceptrons and have the abilities to solve linear inseparable problems by stacking a plurality of perceptrons in multiple layers. Deep learning is a method that introduces new technologies such as dropout into neural networks and is spotlighted as a method that can achieve high prediction accuracies. As described above, until now, machine learning technologies are developed for the purpose of improving the prediction accuracies, and the prediction accuracies show the abilities higher than that of human beings.

When machine learning technologies are implemented in society, there are issues in addition to the prediction accuracies. Examples thereof include security, a method of updating a model after delivery, and restrictions on the use of finite resources such as memory.

Examples of the security issues include data confidentiality. For example, in a medical field or a financial field, when a prediction model using data including personal information is generated, it may be difficult to move the data to the outside of the base where the data is stored due to the high data confidentiality. Generally, in machine learning, high prediction accuracy can be achieved by using a large amount of data for learning.

When learning is performed by using only data acquired at one base, the learning can be a model that can be used only in a very local range due to a small number of data samples or regional characteristics. That is, machine learning technologies that can generate prediction models that realize high predictions for all of the various data at respective bases without having to take out the data from the bases are required.

In H. Brendan McMahan, Eider Moore, Daniel Ramage, Seth Hampson and Blaise Aguera y Arcas, “Communication-efficient learning of deep networks from decentralized data”, In Artificial Intelligence and Statistics, pp. 1273-1282, 2017, the above problem of the data confidentiality is overcome by the federated learning technology. With one common model as the initial value, learning is performed with each data of each base, and a prediction model is generated. The model parameter of the generated prediction model is transmitted to the server, a process of generating the global prediction model from the model parameter of the prediction model is repeated by using a coefficient according to the amount of the data learned from the server. Finally, a global prediction model for achieving high prediction accuracy for the data of all bases is generated. In addition, in De Lange, M., Aljundi, R., Masana, M., Parisot, S., Jia, X., Leonardis, A., Slabaugh, G. and Tuytelaars, T., “Continual learning: A comparative study on how to defy forgetting in classification tasks”, arXiv preprint arXiv:1909.08383 2019, continual learning is disclosed.

In the federated learning technology as in H. Brendan McMahan, Eider Moore, Daniel Ramage, Seth Hampson and Blaise Aguera y Arcas, “Communication-efficient learning of deep networks from decentralized data”, In Artificial Intelligence and Statistics, pp. 1273-1282, 2017, as there are many repetitions of the generation of the prediction model at each base and the generation of the global prediction model in the server, until the global prediction model is determined, the time and the communication amount between the bases and the server increase.

In addition, when the new data increases at base, or when a different base appears, it is required to restart the generation of the integrated prediction model at bases including bases including once learned data. This is because, generally, in the machine learning, if new data is learned, catastrophic forgetting, in which the knowledge of the data learned before is lost, occurs. In such a case, it is required to continuously store the height of the redundancy of the relearning of the once learned data and the data.

That is, the data is collected and stored on a daily basis, and thus, as in De Lange, M., Aljundi, R., Masana, M., Parisot, S., Jia, X., Leonardis, A., Slabaugh, G. and Tuytelaars, T., “Continual learning: A comparative study on how to defy forgetting in classification tasks”, arXiv preprint arXiv:1909.08383 2019, there is a high demand of frequently updating a prediction model by continual learning to obtain a prediction model that can respond not only to knowledge in the past but also to new knowledge, in services using machine learning.

### SUMMARY OF THE INVENTION

An object of the present invention is to achieve the efficiency of federated learning.

An integration device according to an aspect of the invention disclosed in the present application is an integration device including a processor that executes a program; and a storage device that stores the program, in which the processor performs a reception process of receiving a knowledge coefficient relating to first training data in a first prediction model of a first training device from the first training device, a transmission process of transmitting the first prediction model and data relating to the knowledge coefficients of the first training data received in the reception process respectively to a plurality of second training devices, and an integration process of generating an integrated prediction model by integrating a model parameter in a second prediction model generated by training the first prediction model with second training data and the data relating to the knowledge coefficients respectively by the plurality of second training devices, as a result of transmission by the transmission process.

A training device according to an aspect of the invention disclosed in the present application is a training device including a processor that executes a program; and a storage device that stores the program, in which the processor performs a training process of training a training target model with first training data to generate a first prediction model, a first transmission process of transmitting a model parameter in the first prediction model generated in the training process to a computer, a reception process of receiving an integrated prediction model generated by integrating the model parameter and another model parameter in another first prediction model of another training device by the computer as the training target model from the computer, a knowledge coefficient calculation process of calculating a knowledge coefficient of the first training data in the first prediction model if the integrated prediction model is received in the reception process, and a second transmission process of transmitting the knowledge coefficient calculated in the knowledge coefficient calculation process to the computer.

A training device according to another aspect of the invention disclosed in the present application is a training device including a processor that executes a program; and a storage device that stores the program, in which the processor performs a first reception process of receiving a first integrated prediction model obtained by integrating the plurality of first prediction models and data relating to the knowledge coefficient for each item of the first training data used for training the respective first prediction models from the computer, a training process of training the first integrated prediction model received in the first reception process as a training target model with second training data and the data relating to the knowledge coefficient received in the first reception process to generate a second prediction model, and a transmission process of transmitting a model parameter in the second prediction model generated in the training process to the computer.

According to a representative embodiment of the present invention, efficiency of federated learning can be achieved. Issues, configurations, and effects in addition to those described above are clarified by the description of the following examples.

### BRIEF DESCRIPTION OF THE DRAWINGS

FIG. 1 is an explanatory diagram illustrating an example of federated learning;

FIG. 2 is an explanatory diagram illustrating a federated learning example of preventing catastrophic forgetting according to Example 1;

FIG. 3 is a block diagram illustrating a hardware configuration example of a computer;

FIG. 4 is a block diagram illustrating a functional configuration example of the computer according to Example 1;

FIG. 5 is a block diagram illustrating a functional configuration example of a training unit 412;

FIG. 6 is a flowchart illustrating an integration processing procedure example by a server according to Example 1;

FIG. 7 is a flowchart illustrating a training processing procedure example by a base according to Example 1;

FIG. 8 is a flowchart illustrating a specific processing procedure example of a first integration process (Step S601) by the server illustrated in FIG. 6;

FIG. 9 is a flowchart illustrating a specific processing procedure example of a second integration process (Step S602) by the server illustrated in FIG. 6;

FIG. 10 is a flowchart illustrating a specific processing procedure example of a first training process (Step S701) by the base illustrated in FIG. 7;

FIG. 11 is a flowchart illustrating a specific processing procedure example of a second training process (Step S702) by the base illustrated in FIG. 7;

FIG. 12 is an explanatory diagram illustrating Display Example 1 of a display screen;

FIG. 13 is an explanatory diagram illustrating Display Example 2 of the display screen;

FIG. 14 is an explanatory diagram illustrating Display Example 3 of the display screen;

FIG. 15 is an explanatory diagram illustrating Display Example 4 of the display screen;

FIG. 16 is a block diagram illustrating a functional configuration example of a server according to Example 2; and

FIG. 17 is a block diagram illustrating a functional configuration example of a base according to Example 2.

### DESCRIPTION OF EMBODIMENTS

An embodiment of the present invention is described with reference to the drawings. Hereinafter, in all the drawings for describing the embodiment of the present invention, those having basically the same function are denoted by the same reference numerals, and the repeated description thereof is omitted.

### Example 1

<Catastrophic Forgetting>

Generally, in the machine learning, if current training data is learned, catastrophic forgetting, in which knowledge of training data learned before is lost, occurs. For example, image data of an apple and an orange is learned as Phase 1, and image data of a grape and a peach is learned to a prediction model that can identify images of an apple and an orange as Phase 2. Then, the prediction model can identify images of a grape and a peach and cannot identify the images of an apple and an orange.

As a solution, if image data of an apple, an orange, a grape, and a peach is learned based on the prediction model that can identify images of an apple and an orange as Phase 2, a prediction model that can identify images of all of the four kinds is generated. However, in this method, it is required to store the image data of an apple and an orange which is learned in Phase 1, in Phase 2. In addition, compared with a case of training by only using the image data of a grape and a peach of Phase 2, if training is performed by using the both image data of Phase 1 and Phase 2, the number of items of data to be learned increases, and thus a long period of time is required for the training.

As the catastrophic forgetting assumed when the machine learning technology is implemented in society, a medical field and a financial field are considered. In the field of cancer treatment, the evolution of treatment methods such as the development of new therapeutic agents and the improvement of proton beam irradiation technology is rapid. In order to predict therapeutic effects according to the latest medical technologies, it is required to update the prediction model according to the evolution of a treatment method. In the investment field, in order to predict profit and loss to which rapidly changing social conditions are reflected, the update of the prediction model obtained by adding not only training data of the latest transactions but also training data in the past over many years that are influenced by employment statistics and business condition indexes that are important factors or by natural disasters is required.

Particularly, in the medical field or the financial field, if the prediction model is generated by using training data including personal information, due to high training data confidentiality, it may be difficult to move the corresponding training data out of a base that stores the training data. As a solution, a method using federated learning is considered.

The federated learning is a training method of performing training with each training data of each base by using one common prediction model as an initial value and generating prediction models for respective bases. In the federated learning, both of the new training data generated together with the elapse of time and the training data learned in the past can be predicted. Model parameters of the generated prediction models of the respective bases are transmitted to a server. The server integrates the model parameters of the respective bases and generates integrated prediction models. By repeating such a process, the integrated prediction model achieves desired prediction accuracies.

<Federated Learning>

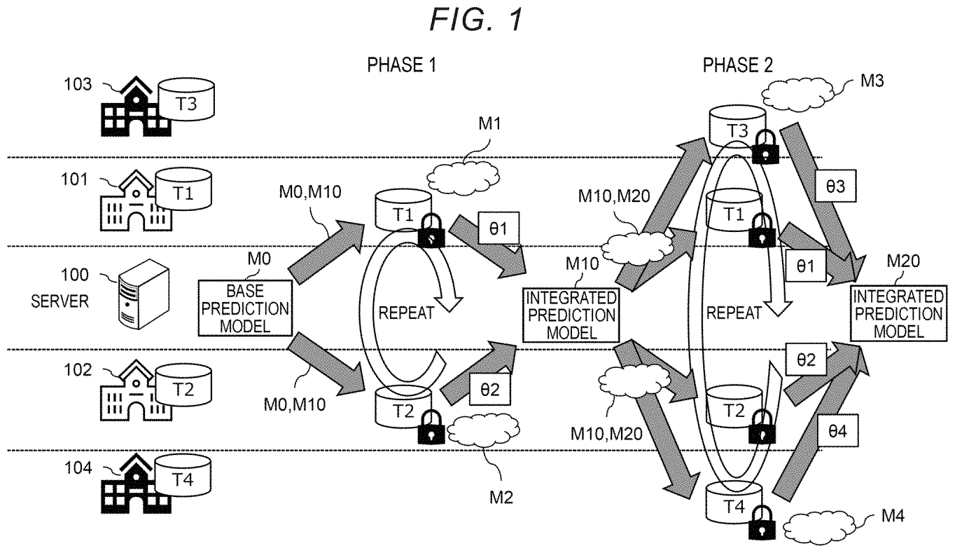

FIG. 1 is an explanatory diagram illustrating an example of federated learning. A plurality of bases as the training device in FIG. 1 (four bases 101 to 104 in FIG. 1, as an example) store training data T1 to T4 (in case of not discriminating these, simply referred to as the training data T) respectively and are prohibited from leaking the training data T1 to T4 out of bases 101 to 104.

A server 100 is an integration device that integrates prediction models M1 to M4 generated at the bases 101 to 104. The server 100 includes a prediction model (hereinafter, referred to as a base prediction model) M0 as a base. A base prediction model M0 may be an untrained neural network and may be a trained neural network to which a model parameter referred to as a weight or a bias is set.

The bases 101 to 104 are computers that include the training data T1 to T4 and generate the prediction models M1 to M4 with the training data T1 to T4. The training data T1 to T4 each are a combination of input training data and correct answer data.

At Phase 1, the training data T1 of the base 101 and the training data T2 of the base 102 are used, and at Phase 2, in addition to the training data T1 of the base 101 and the training data T2 of the base 102 used at Phase 1, the training data T3 of the base 103 and the training data T4 of the base 104 are to be used.

[Phase 1]

At Phase 1, the server 100 transmits the base prediction model M0 to the bases 101 and 102. The base 101 and the base 102 are trained by using the base prediction model M0 and the respective training data T1 and T2 and generate the prediction models M1 and M2.

The base 101 and the base 102 transmit the model parameters θ1 and θ2 referred to as weights or biases of the prediction models M1 and M2, to the server 100. The server 100 performs an integration process of the received model parameters θ1 and θ2 and generates an integrated prediction model M10. The server 100 repeats an update process of the integrated prediction model M10 until the generated integrated prediction model M10 achieves a desired prediction accuracy. In addition, the bases 101 and 102 may transmit gradients of the model parameters θ1 and θ2 of the prediction models M1 and M2 and the like to the server 100.

The integration process is a process of calculating an average value of the model parameters θ1 and θ2. If the number of samples of the training data T1 and T2 are different, the weighted average may be calculated based on the number of samples of the training data T1 and T2. In addition, the integration process may be a process of calculating the average value of respective gradients of the model parameters θ1 and θ2 transmitted from the respective bases 101 and 102, instead of the model parameters θ1 and θ2.

The update process of the integrated prediction model M10 is a process in which the server 100 transmits the integrated prediction model M10 to the bases 101 and 102, the bases 101 and 102 respectively input the training data T1 and T2 to the integrated prediction model M10 for learning and transmit the model parameters θ1 and θ2 of the regenerated prediction models M1 and M2 to the server 100, and the server 100 regenerates the integrated prediction model M10. If the generated integrated prediction model M10 achieves a desired prediction accuracy, Phase 1 ends.

[Phase 2]

At Phase 2, the server 100 transmits the integrated prediction model M10 generated at Phase 1 to the bases 101 to 104. The bases 101 to 104 respectively input the training data T1 to T4 to the integrated prediction model M10 for learning and generate the prediction models M1 to M4. Also, the bases 101 to 104 respectively transmit the model parameters θ1 to θ4 of the generated prediction models M1 to M4 to the server 100. Note that, the bases 101 to 104 may transmit gradients of the model parameters θ1 to θ4 of the prediction models M1 to M4 and the like to the server 100.

The server 100 performs an integration process of the received model parameters θ1 to θ4 to generate an integrated prediction model M20. The server 100 repeats the update process of the integrated prediction model M20 until the generated integrated prediction model M20 achieves the desired prediction accuracy.

In the integration process at Phase 2, the average value of the model parameters θ1 to θ4 is calculated. The numbers of items of data of the training data T1 to T4 are different from each other, the weighted average may be calculated based on the numbers of items of data of the training data T1 to T4. In addition, the integration process may be a process of calculating average value of respective gradients of the model parameters θ1 to θ4 transmitted respectively from the bases 101 to 104 instead of the model parameters θ1 to θ4.

In the update process of the integrated prediction model M20 at Phase 2, the server 100 transmits the integrated prediction model M20 to the bases 101 to 104, the bases 101 to 104 respectively input the training data T1 to T4 to the integrated prediction model M20 for learning and transmit the model parameters θ1 to θ4 of the regenerated prediction models M1 to M4 to the server 100, and the server 100 regenerates the integrated prediction model M20. If the generated integrated prediction model M20 achieves a desired prediction accuracy, Phase 2 ends.

If the repetition of the update process is ignored, the transmission and reception between the server 100 and the bases 101 to 104 are performed 12 times in total, four times at Phase 1 and eight times at Phase 2 (the number of arrows). If the repetition of the update process is added, four times the number of repetition at Phase 1 and eight times the number of repetition at Phase 2 are further required.

In addition, respective bases calculate the prediction accuracies at Phases 1 and 2 by applying test data other than the training data T1 to T4 to the integrated prediction models M10 and M20. Specifically, for example, if the integrated prediction models M10 and M20 are regression models, the prediction accuracy is calculated as a mean square error, a root mean square error, or a determination coefficient, and if the integrated prediction models M10 and M20 are classification models, the prediction accuracy is calculated as a correct answer rate, a precision rate, a recall rate, or an F value. In addition, data for accuracy calculation of the integrated prediction model that is stored in the server 100 or the like may be used.

<Federated Learning for Preventing Catastrophic Forgetting>

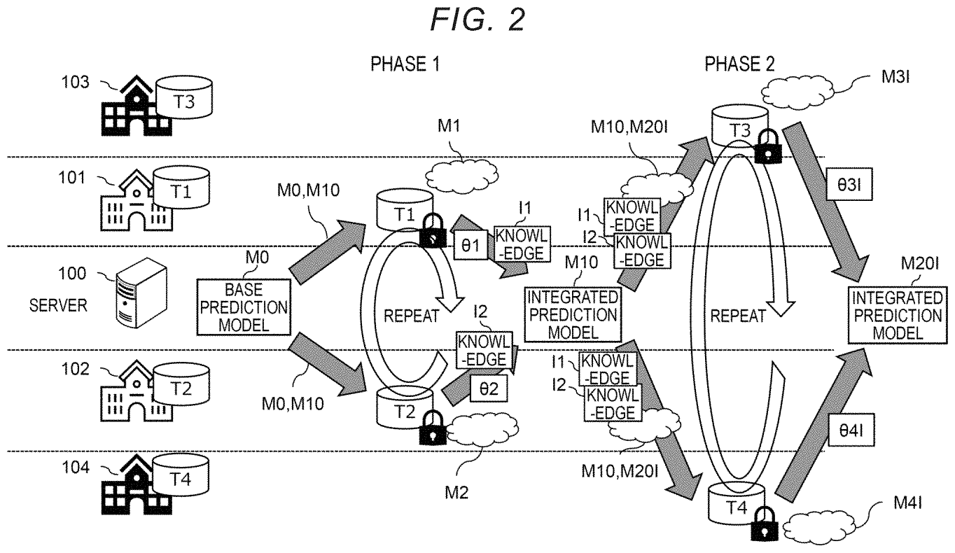

FIG. 2 is an explanatory diagram illustrating a federated learning example for preventing catastrophic forgetting according to Example 1. In FIG. 2, differences from FIG. 1 are mainly described. Phase 1 is substantially the same as the federated learning illustrated in FIG. 1. The difference from the federated learning illustrated in FIG. 1 is that, if the generated integrated prediction model M10 achieves a desired prediction accuracy, the bases 101 and 102 calculate a knowledge coefficient I1 of the training data T1 with respect to the prediction model M1 and a knowledge coefficient I2 of the training data T2 with respect to the prediction model M2 and transmit the knowledge coefficients to the server 100. The knowledge coefficients I1 and I2 are coefficients of regularization terms that configure a loss function, which is obtained by collecting and storing knowledge of the training data T1 and T2.

In addition, the integrated prediction model M10 may be used for calculation of each knowledge coefficient. Otherwise, the prediction model M1 and the integrated prediction model M10 may be used for calculation of the knowledge coefficient I1, and the prediction model M2 and the integrated prediction model M10 may be used for calculation of the knowledge coefficient I2.

At Phase 2, the server 100 transmits the integrated prediction model M10 and the knowledge coefficients I1 and I2 generated at Phase 1 to the bases 103 and 104, respectively. The bases 103 and 104 respectively input the training data T3 and T4 to the integrated prediction model M10 for learning and generate prediction models M3I and M4I by adding the knowledge coefficients I1 and I2. Also, the bases 103 and 104 respectively transmit model parameters θ3I and θ4I of the generated prediction models M3I and M4I to the server 100. In addition, the bases 103 and 104 may transmit gradients of the model parameters θ3I and θ4I of the prediction models M3I and M4I and the like to the server 100.

The server 100 performs the integration process of the received model parameters θ3I and θ4I and generates an integrated prediction model M20I. The server 100 repeats the update process of the integrated prediction model M20I until the generated integrated prediction model M20I achieves a desired prediction accuracy.

In the integration process at Phase 2, the average value of the model parameters θ3I and θ4I is calculated. If the numbers of items of data of the training data T3 and T4 are different from each other, a weighted average may be calculated based on the numbers of items of data of the training data T3 and T4. In addition, the integration process may be a process of calculating an average value of the respective gradients of the model parameters θ3I and θ4I transmitted from the respective bases, instead of the model parameters θ3I and θ4I.

In the update process of the integrated prediction model M20I at Phase 2, the server 100 transmits the integrated prediction model M20I to the bases 103 and 104, the bases 103 and 104 respectively input the training data T3 and T4 to the integrated prediction model M20I for learning, transmit the model parameters θ3I and θ4I of the regenerated prediction models M3I and M4I to the server 100 by adding the knowledge coefficients I1 and I2, and the server 100 regenerates the integrated prediction model M20I. If the generated integrated prediction model M20I achieves a desired prediction accuracy, Phase 2 ends.

The bases 103 and 104 respectively use the knowledge coefficient I1 of the training data T1 of the base 101 and the knowledge coefficient I2 of the training data T2 of the base 102 for learning. Accordingly, the bases 103 and 104 do not use the training data T1 of the base 101 and the training data T2 of the base 102 again, respectively, and the server 100 can generate the integrated prediction model M20I that can predict the training data T1 of the base 101, the training data T2 of the base 102, the training data T3 of the base 103, and the training data T4 of the base 104.

If the repetition of update process is ignored, the transmission and reception between the server 100 and the bases 101 to 104 are performed eight times in total, four times at Phase 1 and four times at Phase 2 (the number of arrows), and the repetition is reduced to ⅔ compared with FIG. 1.

In addition, if the repetition of the update process is added, four times the number of repetitions at Phase 1 and four times the number of repetitions at Phase 2 are further required. As the number of repetitions at Phase 2 is reduced to a half, a total number of times of the transmission and reception can be reduced. In addition, in the training of Phase 2, since the training data T1 of the base 101 and the training data T2 of the base 102 are not used for the training, the training data is not required to be stored, and the capacity of the storage device of the server 100 for the training data is used for storing other processes or data or the like so that the operational efficiency can be realized.

In addition, at Phase 1, the bases 101 and 102 are present, but only the base 101 may be present. In this case, the server 100 does not have to generate the integrated prediction model M10, and the prediction model M1 that is a calculation source of the knowledge coefficient I1 and the knowledge coefficient I1 may be transmitted to the bases 103 and 104. Hereinafter, the federated learning for preventing catastrophic forgetting illustrated in FIG. 2 is specifically described.

<Hardware Configuration Example of Computer (Server 100 and Bases 101 to 104)>

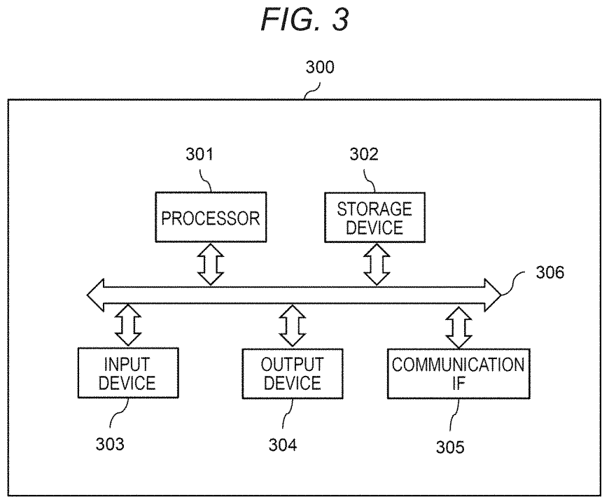

FIG. 3 is a block diagram illustrating a hardware configuration example of the computer. A computer 300 includes a processor 301, a storage device 302, an input device 303, an output device 304, and a communication interface (communication IF) 305. The processor 301, the storage device 302, the input device 303, the output device 304, and the communication IF 305 are connected to each other via a bus 306. The processor 301 controls the computer 300. The storage device 302 becomes a work area of the processor 301. In addition, the storage device 302 is a non-temporary or temporary storage medium that stores various programs or data. Examples of the storage device 302 include a read only memory (ROM), a random access memory (RAM), a hard disk drive (HDD), and a flash memory. The input device 303 inputs data. Examples of the input device 303 include a keyboard, a mouse, a touch panel, a numeric keypad, and a scanner. The output device 304 outputs data. Examples of the output device 304 include a display and a printer. The communication IF 305 is connected to a network and transmits and receives data.

<Functional Configuration Example of Computer 300>

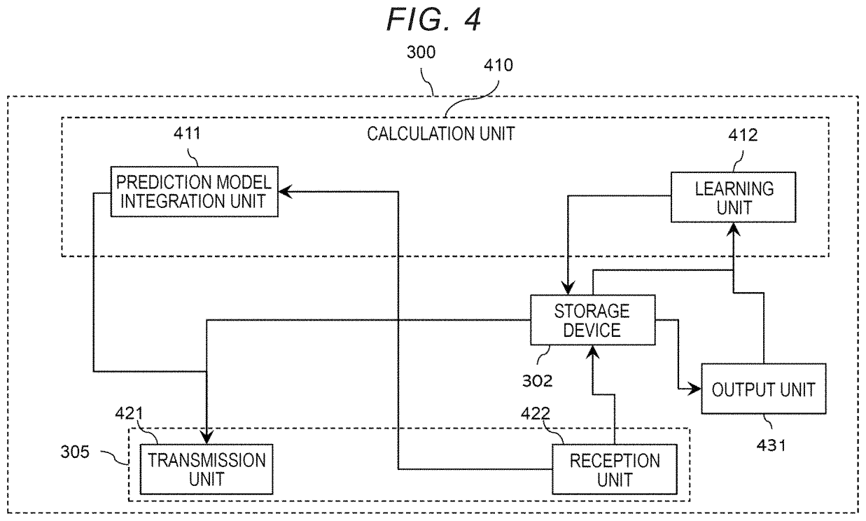

FIG. 4 is a block diagram illustrating a functional configuration example of the computer 300 according to Example 1. The computer 300 includes a calculation unit 410 including a prediction model integration unit 411 and a training unit 412, the communication IF 305 including a transmission unit 421 and a reception unit 422, the storage device 302, and an output unit 431.

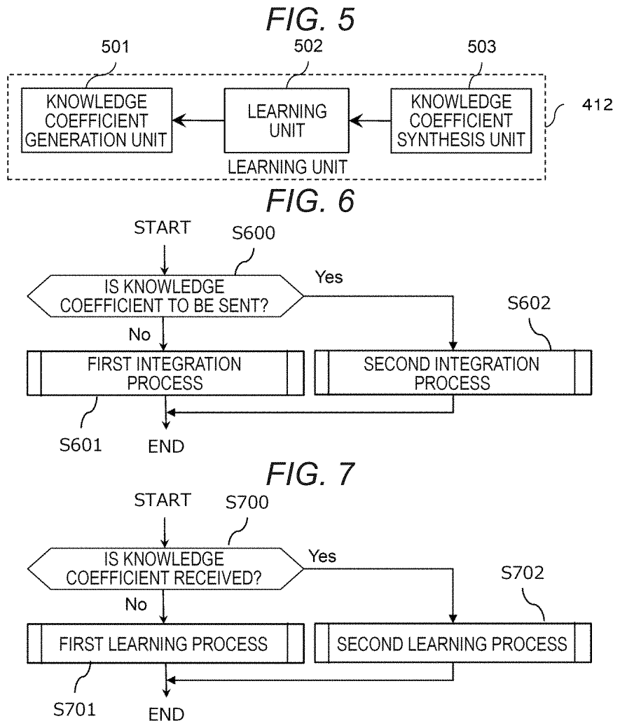

FIG. 5 is a block diagram illustrating a functional configuration example of the training unit 412. The training unit 412 includes a knowledge coefficient generation unit 501, a training unit 502, and a knowledge coefficient synthesis unit 503. Specifically, the calculation unit 410 and the output unit 431 are realized, for example, by executing a program stored in the storage device 302 illustrated in FIG. 3 by the processor 301.

The prediction model integration unit 411 performs an integration process of generating the integrated prediction models M10 and M20I respectively based on model parameters (θ1 and θ2) and (θ3 and θ4) of the prediction models (M1 and M2) and (M3 and M4) transmitted from the plurality of bases 101 to 104. For example, a prediction model that learns the feature amount vector x in the training data T is expressed by using an output y, the model parameter θ, and a function h of the model as shown in Expression (1).

y=h(x;θ) Expression (1)

At Phase 2, with respect to the integrated prediction model M10 configured with model parameters θ^{t} generated by the training at respective bases (the bases 101 and 102 in FIG. 2), the server 100 uses the sum of averages of gradients gk relating to model parameters θₖ of K prediction models (the prediction models M3I and M4I in FIG. 2) respectively generated by the training with K items of different training data (T3 and T4 in FIG. 2) at K (K=2 of Phase 2 in FIG. 2) bases (the bases 103 and 104 in FIG. 2), to generate model parameters θ^{t+1} of the integrated prediction model M20I as shown in Expression (2). In Expression (2), η is a learning rate, N is a total number of samples of all training data (T3 and T4 in FIG. 2) used for training at K bases, and Nk is the number of samples of data used for training at a base k.

$${θ}^{t + 1} ← {θ}^{t} - η {{\sum }_{k = 1}}^{K} \frac{{N}_{k}}{N} {g}_{k} \qquad Expression ( 2 )$$

Herein in Expression (2), the gradient gk relating to the model parameter θₖ (the model parameters θ3I and θ4I in FIG. 2) of the prediction models (the prediction models M3I and M4I in FIG. 2) respectively generated by the training of k items of different training data Tk at k bases is used, but this is a method considering the security so that the training data (T3 and T4 in FIG. 2) cannot be analyzed, and the model parameter θₖ, encoding, encryption, and the like may be used. In addition, the prediction models M3I and M4I may be integrated by a method different from Expression (2) according to the structure of prediction models (the prediction models M3I and M4I in FIG. 2) such as a fully connected layer and a convolution layer, the design of a loss function.

The training unit 412 starts from a prediction model configured with a model parameter determined by a random initial value or the base prediction model M0 and is trained by using the training data T, to generate a prediction model and synthesize a knowledge coefficient by the knowledge coefficient synthesis unit 503. In addition, the training unit 412 is trained by using a synthesis knowledge coefficient synthesized by the knowledge coefficient synthesis unit 503 and the training data T, to generate a prediction model.

Specifically, for example, if the computer 300 is the bases 101 and 102, the training unit 412 acquires the base prediction model M0 from the server 100 and is trained by using the training data T1, to generate the prediction model M1 and generate the knowledge coefficient I1 with the knowledge coefficient generation unit 501. With respect to the base 102, in the same manner, the prediction model M2 is generated by using the training data T2 and the knowledge coefficient I2 is generated with the knowledge coefficient generation unit 501.

In addition, if the computer 300 is the base 103, when the knowledge coefficients I1 and I2 of the bases 101 and 102 are acquired from the server 100, the training unit 412 synthesizes the knowledge coefficients with the knowledge coefficient synthesis unit 503. With respect to the base 104, in the same manner, when the knowledge coefficients I1 and I2 of the bases 101 and 102 are acquired from the server 100, the training unit 412 synthesizes the knowledge coefficients with the knowledge coefficient synthesis unit 503. In addition, in the bases 103 and 104, the knowledge coefficient generation unit 501 may generate knowledge coefficients I3 and I4 in preparation for the future increase of bases.

In addition, in the bases 103 and 104, the training unit 412 may generate the prediction model M3I by using a synthesis knowledge coefficient generated with the knowledge coefficient synthesis unit 503 of the server 100 and the training data T3 of the base 103. With respect to the base 104, in the same manner, the training unit 412 generates the prediction model M4I by using a synthesis knowledge coefficient synthesized with the knowledge coefficient synthesis unit 503 of the server 100 and the training data T4 of the base 104.

By using Expression (1), the training unit 502 sets a loss function L (θₘ) for calculating a model parameter θₘ so that an error from a predicted value yₘ obtained from a feature amount vector xₘ of input training data Tₘ and a correct answer label tₘ that is an actual value or an identification class number is minimized. m is a number for identifying the training data T.

Specifically, for example, the training unit 502 sets a past knowledge term R (θₘ) using a synthesis knowledge coefficient synthesized by the knowledge coefficient synthesis unit 503 relating to the training data Tₘ in the past that is desired to be considered among knowledge coefficients for each item of the training data T learned in the past which are generated by the knowledge coefficient generation unit 501.

The loss function L (θₘ) is expressed by the sum of an error function E (θₘ) and the past knowledge term R (θₘ) as shown in Expression (3).

L(θₘ)=E(θₘ)+R(θₘ) Expression (3)

For example, as shown in Expression (4), the past knowledge term R (θₘ) is expressed by a coefficient λ of a regularization term, a synthesis knowledge coefficient Ω^{ij} generated by the knowledge coefficient synthesis unit 503, the model parameter θₘ obtained by the training, and a model parameter θ_{B} of the base prediction model M0. In addition, i and j represent the j-th unit of the i-th layer in a prediction model M.

$$R ( {θ}_{m} ) = λ {\sum }_{ij} {{Ω}^{i , j} ( {θ}_{m}^{ij} - {θ}_{B}^{ij} )}^{2} \qquad Expression ( 4 )$$

The knowledge coefficient generation unit 501 calculates the knowledge coefficient I by using the training data T and the prediction model M learned and generated by using the training data T, to extract the knowledge of the training data T. Specifically, for example, there is a method of extracting knowledge by using the knowledge coefficient I in a regularization term.

As shown in Expression (5), a knowledge coefficient I^{ij} (xₘ;θₘ) is generated by differentiation by a model parameter θᵢⱼ of the output of the prediction model M configured with the model parameter θₘ that is learned and generated by using the training data Tₘ. The knowledge coefficient Iii (xₘ;θₘ) relating to the training data Tₘ is generated by using only the training data Tₘ and the prediction model M generated by using the training data Tₘ, and thus it is not required to store the training data T in the past or the prediction model M (for example, the training data T1 and T2 and the prediction models M1 and M2 of FIG. 2). In addition, the training data T in the past or the prediction model M is not required to be stored for generating, in the future, the knowledge coefficient I^{ij} (xₘ;θₘ) relating to the training data Tₘ, the knowledge coefficient I^{ij} (xₘ; θₘ₊₁) generated by using the model parameter θₘ₊₁ that is learned and generated by using the training data Tₘ₊₁ in the future from the time when the training data Tₘ is learned, or the like.

$${I}^{ij} ( {x}_{m} ; {θ}_{m} ) = \frac{\partial ‖ {h}_{m} ( {x}_{m} ; {θ}_{m} ) ‖}{\partial {θ}^{ij}} \qquad Expression ( 5 )$$

The knowledge coefficient synthesis unit 503 synthesizes a plurality of knowledge coefficients generated by using the training data T desired to be introduced among knowledge coefficient groups generated by the knowledge coefficient generation unit 501, to generate synthesis knowledge coefficients. Specifically, for example, the knowledge coefficient synthesis unit 503 of the server 100 or the base 103 or 104 synthesizes the plurality of knowledge coefficients I1 and I2 generated by using the training data T1 and T2 to generate the synthesis knowledge coefficients Ω (I1 and I2).

As shown in Expression (6), the knowledge coefficient synthesis unit 503 calculates the sum of the respective knowledge coefficients I desired to be introduced, in a sample p direction in the feature amount vector xₘ of the training data Tₘ based on U where identification numbers of the knowledge coefficients I desired to be introduced are stored and performs normalization on a total number of samples. In the present example, a method of introducing and storing knowledge of specific data by using a regularization term of the L2 norm type is used, but the method may be the L1 norm type, Elastic net, or the like, the knowledge stored by converting data may be used as in a Replay-based method, a Parameter isolation-based method, or the like, and a result obtained by applying the training data Tₘ learned from now on, to the base prediction model M0 or a network path may be used.

$${Ω}^{ij} = \frac{1}{P} {{\sum }_{p = 1}}^{P} {{\sum }_{l}}^{U} ‖ {I}^{ij} ( {x}_{l} ( p ) ; ( {θ}_{l} ) ‖ \qquad Expression ( 6 )$$

The transmission unit 421 transmits various kinds of data. Specifically, for example, if the computer 300 is the server 100, the transmission unit 421 transmits the base prediction model M0 and the first integrated prediction model M10 to the bases 101 and 102 at the time of the training at respective bases (Phase 1). In addition, at the time of the training at respective bases (Phase 2), the transmission unit 421 transmits the integrated prediction models M10 and M20I generated by the prediction model integration unit and the knowledge coefficients I1 and I2 (or the synthesis knowledge coefficients Ω (I1, I2)), to the bases 103 and 104. In addition, the transmission unit 421 transmits whether to continue or end the repetition of the federated learning, from results of accuracy verification performed at each of the bases, to each of the bases.

In addition, if the computer 300 is the base 101 or 102, the transmission unit 421 transmits the learned model parameters θ1 and θ2, all the knowledge coefficients I1 and I2 so far or the knowledge coefficients I1 and I2 input from an operator to be used for training at the respective bases 101 and 102, and accuracy verification results of the prediction models M1 and M2, to the server 100 at the time of training at each of the bases 101 and 102 (Phase 1).

In addition, if the computer 300 is the base 103 or 104, the transmission unit 421 transmits the learned model parameters θ3I and θ4I and the accuracy verification results of the prediction models M3I and M4I to the server 100 at the time of training at each of the bases 103 and 104 (Phase 2).

The reception unit 422 receives various kinds of data. Specifically, for example, if the computer 300 is the server 100, the model parameters θ1 and θ2, the knowledge coefficients I1 and I2, and the prediction accuracy verification results of the prediction models M1 and M2 are received from the bases 101 and 102 at the time of the prediction model integration (Phase 1). In addition, the reception unit 422 receives the model parameters θ3I and θ4I or the accuracy verification results of the prediction models M3I and M4I, from the bases 103 and 104 at the time of prediction model integration (Phase 2).

In addition, if the computer 300 is the base 101 or 102, the reception unit 422 receives the base prediction model M0 and the first integrated prediction model M10 at the time of training (Phase 1), at each of the bases 101 and 102. In addition, if the computer 300 is the base 103 or 104, the reception unit 422 receives the integrated prediction models M10 and M20I or the knowledge coefficients I1 and I2 (or the synthesis knowledge coefficient Ω) at the time of the training (Phase 2) at each of the bases 103 and 104.

In addition, the transmitted and received data is converted by encryption or the like from the viewpoint of security. Accordingly, the analysis of the data used for the training from the prediction model M becomes difficult.

### Integration Processing Procedure Example

FIG. 6 is a flowchart illustrating an integration processing procedure example by the server 100 according to Example 1. The server 100 determines whether to send the knowledge coefficient I to the base (Step S600). If the knowledge coefficient I is not sent to the base (Step S600: No), this case means the start of Phase 1. Therefore, the server 100 performs a first integration process for integrating the plurality of prediction models M1 and M2 (Step S601).

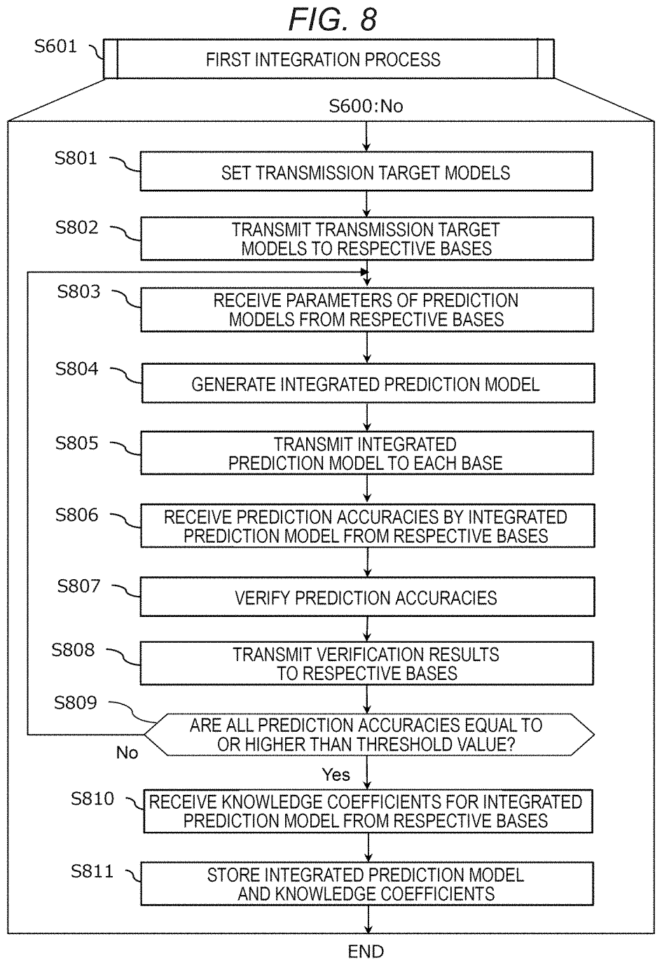

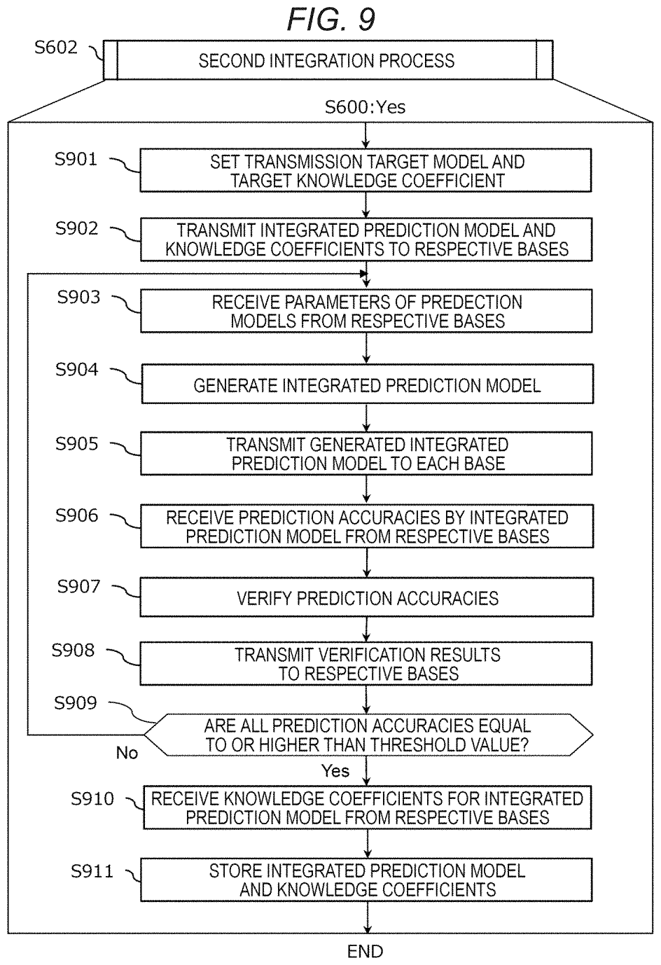

Meanwhile, if the knowledge coefficient I is sent to the base (Step S600: Yes), Phase 1 is completed. Accordingly, the server 100 performs a second integration process for integrating the plurality of prediction models M3 and M4 (Step S602). In addition, details of the first integration process (Step S601) are described below with reference to FIG. 8, and details of the second integration process (Step S602) are described below with reference to FIG. 9. In addition, even if the knowledge coefficient I is not transmitted, an identification reference numeral indicating Phase 1 or Phase 2 is transmitted together with the base prediction model M0 or an integrated prediction model used as the base prediction model M0, and according to the transmission, which of Step S601 and Step S602 is to be performed may be determined.

### Training Processing Procedure Example

FIG. 7 is a flowchart illustrating a training processing procedure example by the base according to Example 1. The base determines whether the knowledge coefficient I is received from the server 100 (Step S700). If the knowledge coefficient I is not received (No in Step S700), the corresponding base is a base (for example, the base 101 or 102) that is trained without using the knowledge coefficient I. Accordingly, the corresponding base 101 or 102 performs a first training process (Step S701).

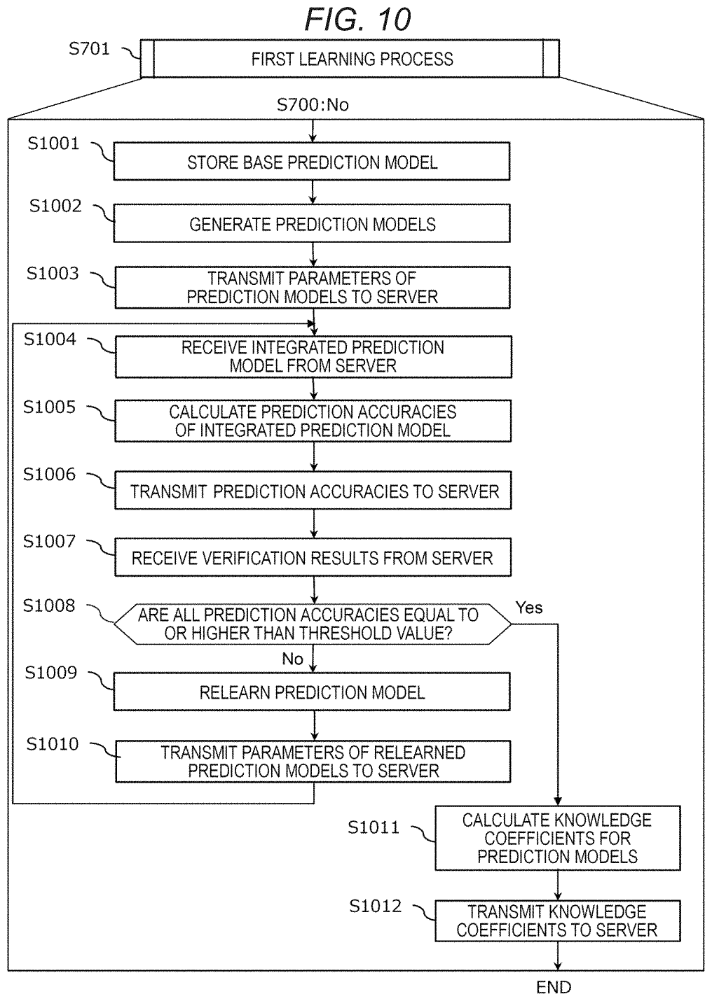

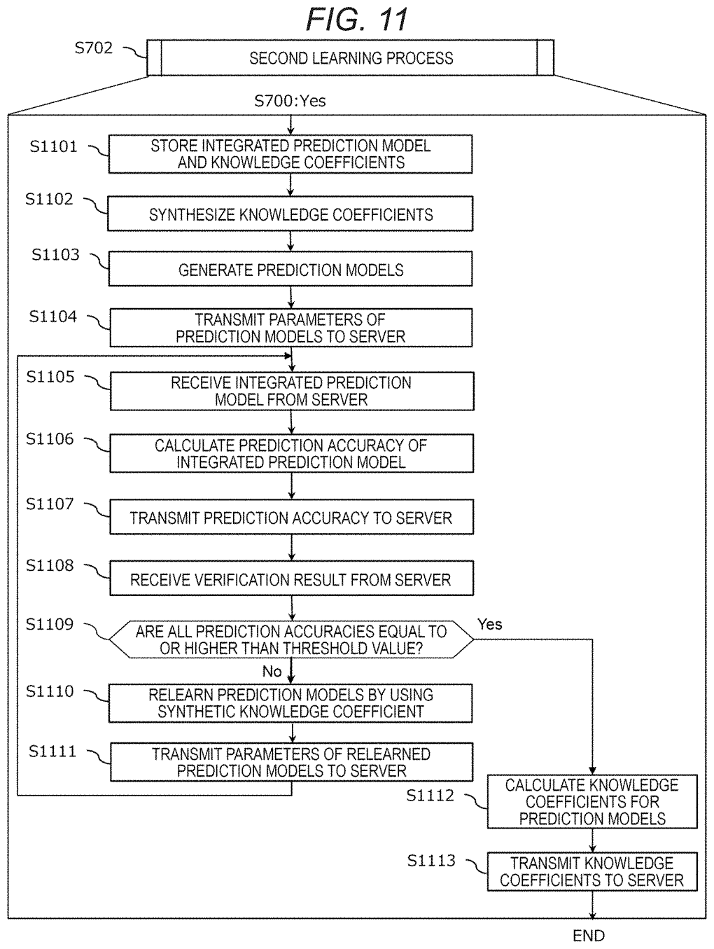

Meanwhile, if the knowledge coefficient I is received (Yes in Step S700), the corresponding base is a base (for example, the base 103 or 104) that performs federated learning by using the knowledge coefficient I. The corresponding base 103 or 104 performs a second training process (Step S702). In addition, details of the first training process (Step S701) are described below with reference to FIG. 10, and details of the second training process (Step S702) are described below with reference to FIG. 11. In addition, even if the knowledge coefficient is not received, the identification reference numeral of Phase 1 or Phase 2 is received together with the base prediction model M0 or the integrated prediction model M used as the base prediction model M0, and according to the reception, which of Step S701 and Step S702 is to be performed may be determined.

<First Integration Process (Step S601)>

FIG. 8 is a flowchart illustrating a specific processing procedure example of the first integration process (Step S601) by the server 100 illustrated in FIG. 6. The server 100 sets a transmission target model to the bases 101 and 102 determined as transmission destinations in case of No in Step S600 (Step S801). Specifically, if the base prediction model M0 is not yet transmitted, for example, the server 100 sets the base prediction model M0 to a transmission target, and if transmission is completed in the past, and there is an instruction of setting the integrated prediction model M10 generated at that moment to the base prediction model at the time of setting the transmission target model in Step S801, the integrated prediction model M10 is set to the transmission target. In the latter case, since the knowledge coefficient I relating to the past knowledge of the data learned in the past is not transmitted together, the knowledge of the data learned in the past is forgotten in the newly generated prediction model M. Also, the server 100 transmits the transmission target model to each of the bases 101 and 102 (Step S802).

Next, the server 100 receives the model parameters θ1 and θ2 of the prediction models M1 and M2 from the respective bases 101 and 102 (Step S803). Then, the server 100 generates the integrated prediction model M10 by using the received model parameters θ1 and θ2 (Step S804). Then, the server 100 transmits the generated integrated prediction model M10 to each of the bases 101 and 102 (Step S805).

Next, the server 100 receives prediction accuracies by the integrated prediction model M10 from the respective bases 101 and 102 (Step S806). Then, the server 100 verifies the respective prediction accuracies (Step S807). Specifically, for example, the server 100 determines whether the respective prediction accuracies are a threshold value or more. In addition, the prediction accuracies by the integrated prediction model M10 with respect to the data of the respective bases 101 and 102 are calculated at the respective bases. However, if there is data for evaluation in the server 100, a prediction accuracy by the integrated prediction model M10 with respect to the data for evaluation may be used. Thereafter, the server 100 transmits verification results to the respective bases 101 and 102 (Step S808).

The server 100 determines whether all of the prediction accuracies are the threshold value or more in the verification results (Step S809). If all of the prediction accuracies are not the threshold value or more (No in Step S809), that is, at least one of the prediction accuracies is less than the threshold value, the process returns to Step S803, and the server 100 waits for the model parameters θ1 and θ2 of the prediction models M1 and M2 updated again, from the respective bases 101 and 102.

Meanwhile, if all of the prediction accuracies are the threshold value or more (Yes in Step S809), the respective bases 101 and 102 calculate and transmit the knowledge coefficients I1 and I2 with respect to the integrated prediction model M10, and thus the server 100 receives the knowledge coefficients I1 and I2 with respect to the integrated prediction model M10 from the respective bases 101 and 102 (Step S810). Then, the server 100 stores the integrated prediction model M10 and the knowledge coefficients I1 and I2 to the storage device 302 (Step S811). Accordingly, the first integration process (Step S601) ends.

<Second Integration Process (Step S602)>

FIG. 9 is a flowchart illustrating a specific processing procedure example of the second integration process (Step S602) by the server 100 illustrated in FIG. 6. In case of Yes in Step S600, the server 100 sets the transmission target model and the knowledge coefficients to the bases 103 and 104 determined as the transmission destinations (Step S901). The integrated prediction model M10 and the knowledge coefficients I1 and I2 are transmitted to the bases 103 and 104 determined as the transmission destinations (Step S902). In addition, as the knowledge coefficient, the synthesis knowledge coefficient Ω generated in advance may be transmitted to the server 100.

Next, the server 100 receives the model parameters θ3I and θ4I of the prediction models M3I and M4I from the respective bases 103 and 104 (Step S903). Then, the server 100 generates the integrated prediction model M20I by using the received model parameters θ3I and θ4I (Step S904). Then, the server 100 transmits the generated integrated prediction model M20I to each of the bases 103 and 104 (Step S905).

Next, the server 100 receives the prediction accuracies by the integrated prediction model M20I from the respective bases 103 and 104 (Step S906). Then, the server 100 verifies the respective prediction accuracies (Step S907). Specifically, for example, the server 100 determines whether the respective prediction accuracies are the threshold value or more. Note that, the prediction accuracies by the integrated prediction model M20I with respect to the data of the respective bases 103 and 104 are calculated at the respective bases. However, if there is data for evaluation in the server, a prediction accuracy by the integrated prediction model M20I with respect to the data for evaluation may be used. Thereafter, the server 100 transmits the verification results to the respective bases 103 and 104 (Step S908).

The server 100 determines whether all of the prediction accuracies are the threshold value or more in the verification results (Step S909). If all of the prediction accuracies are not the threshold value or more (No in Step S909), that is, at least one of the prediction accuracies are less than the threshold value, the process returns to Step S903, and the server 100 waits for the model parameters θ3I and θ4I of the integrated prediction model M20I updated again, from the respective bases 103 and 104.

Meanwhile, if all of the prediction accuracies are the threshold value or more (Yes in Step S909), the respective bases 103 and 104 calculate and transmit the knowledge coefficients I3 and I4 with respect to the integrated prediction model M20I, and thus the server 100 receives the knowledge coefficients I3 and I4 with respect to the integrated prediction model M20I from the respective bases 103 and 104 (Step S910). Then, the server 100 stores the integrated prediction model M20I and the knowledge coefficients I3 and I4 in the storage device 302 (Step S911). Accordingly, the second integration process (Step S602) ends.

<First Training process (Step S701)>

FIG. 10 is a flowchart illustrating a specific processing procedure example of the first training process (Step S701) by the bases 101 and 102 illustrated in FIG. 7. In case of No in Step S700, each of the bases 101 and 102 stores the base prediction model M0 from the server 100 in the storage device 302 (Step S1001). In addition, if the base prediction model M0 is the integrated prediction model M10, the knowledge coefficient I relating to the past knowledge of the data learned in the past is not transmitted together, the knowledge of the data learned in the past is forgotten in the newly generated prediction model M.

Next, the respective bases 101 and 102 learn the base prediction model M0 by using the training data T1 and T2 and generate the prediction models M1 and M2 (Step S1002). Then, the respective bases 101 and 102 transmit the model parameters θ1 and θ2 of the prediction models M1 and M2 to the server 100 (Step S1003). Accordingly, in the server 100, the integrated prediction model M10 is generated (Step S804).

Thereafter, the respective bases 101 and 102 receive the integrated prediction model M10 from the server 100 (Step S1004). Then, the respective bases 101 and 102 calculate the prediction accuracies of the integrated prediction model M10 (Step S1005) and transmit the prediction accuracies to the server 100 (Step S1006). Accordingly, in the server 100, the respective prediction accuracies are verified (Step S807).

Thereafter, the respective bases 101 and 102 receive verification results from the server 100 (Step S1007). Then, the respective bases 101 and 102 determine whether all of the prediction accuracies are the threshold value or more in the verification results (Step S1008). If all of the prediction accuracies are not the threshold value or more (No in Step S1008), that is, if at least one of the prediction accuracies is less than threshold value, the respective bases 101 and 102 relearn the integrated prediction model M10 as the base prediction model using the training data T1 and T2 (Step S1009), transmit the model parameters θ1 and θ2 of the prediction models M1 and M2 generated based on the relearning to the server 100 (Step S1010). Then, the process returns to Step S1004, and the respective bases 101 and 102 wait for the integrated prediction model M10 from the server 100.

Meanwhile, if all of the prediction accuracies are the threshold value or more (Yes in Step S1008), the respective bases 101 and 102 calculate the knowledge coefficients I1 and I2 with respect to the prediction models M1 and M2 (Step S1011) and transmit the knowledge coefficients to the server 100 (Step S1012). Accordingly, the first training process (Step S701) ends.

<Second Training process (Step S702)>

FIG. 11 is a flowchart illustrating a specific processing procedure example of the second training process (Step S702) by the bases 101 and 102 illustrated in FIG. 7. The respective bases 103 and 104 that make a transition in case of Yes in Step S700 store the integrated prediction model M10 and the knowledge coefficients I1 and I2 from the server 100 in the storage device 302 (Step S1101).

Next, the respective bases 103 and 104 synthesize the training data T3 and T4 and the knowledge coefficients I1 and I2 and generate the synthesis knowledge coefficient Ω (Step S1102), learn the integrated prediction model M10 using the synthesis knowledge coefficient Ω and generate the prediction models M3I and M4I (Step S1103). In addition, if the knowledge coefficient receives the synthesis knowledge coefficient Ω generated in advance in the server 100, Step S1102 of generating a synthesis knowledge coefficient from the knowledge coefficient I at a base does not have to be performed.

Then, the respective bases 103 and 104 transmit the model parameters θ3I and θ4I of the prediction models M3I and M4I to the server 100 (Step S1104). Accordingly, in the server 100, the integrated prediction model M20I is generated (Step S904).

Next, the respective bases 103 and 104 receive the integrated prediction model M20I from the server 100 (Step S1105). Then, the respective bases 103 and 104 calculate the prediction accuracies of the integrated prediction model M20I (Step S1106), and transmit the prediction accuracies to the server 100 (Step S1107). Accordingly, in the server 100, the respective prediction accuracies are verified (Step S907).

Thereafter, the respective bases 103 and 104 receive verification results from the server 100 (Step S1108). Then, the respective bases 103 and 104 determine whether all of the prediction accuracies are the threshold value or more in the verification results (Step S1109). If all of the prediction accuracies are not the threshold value or more (No in Step S1109), that is, at least one of the prediction accuracies is less than the threshold value, the respective bases 103 and 104 synthesize the knowledge coefficients I1 and I2 and generate the synthesis knowledge coefficient Ω (Step S1110). The synthesis knowledge coefficient Ω generated in Step S1102 may be temporarily stored in the memory and used.

Then, the respective bases 103 and 104 relearn the integrated prediction model M20I as the base prediction model by using the training data T3 and T4 and the synthesis knowledge coefficient Ω (Step S1110), and transmit the model parameters θ3I and θ4I of the prediction models M3I and M4I generated based on the relearning to the server 100 (Step S1111). Then, the process returns to Step S1105, and the respective bases 103 and 104 wait for the integrated prediction model M20I updated again, from the server 100.

Meanwhile, if all of the prediction accuracies are the threshold value or more (Yes in Step S1109), the respective bases 103 and 104 calculate the knowledge coefficients I3 and I4 with respect to the prediction models M3 and M4 (Step S1112) and transmit the knowledge coefficients to the server 100 (Step S1113). Accordingly, the second training process (Step S702) ends.

In this manner, according to the above training system, without moving the training data T1 to T4 in the plurality of bases 101 to 104 out of the bases, by using the knowledge coefficients I1 and I2 of the plurality of training data T1 and T2 learned in the past, without using the training data T1 and T2 learned in the past for the retraining, the prediction model M20 that can predict the training data T1 to T4 in the plurality of bases 101 to 104 can be generated. The integrated prediction model M20I that can predict the training data T1 to T4 that are in the plurality of bases 101 to 104 generated by the repetition of the training at the respective bases 103 and 104 and model integration in the server 100 can be generated.

With respect to the integrated prediction model M20I, if continual learning technologies are applied to the bases 103 and 104, by using the training data T3 and T4 and the knowledge coefficients I1 and I2 of the plurality of items of training data T1 and T2 learned in the past, without using the training data T1 and T2 learned in the past for the retraining, the prediction models that can predict the training data T1 to T4 in the plurality of bases 101 to 104 can be generated. Accordingly, the prediction model M20 that can predict the training data T1 to T4 in the bases 101 to 104 can be generated.

### Display Screen Example

Next, a display screen example displayed on a display that is an example of the output device 304 of the computer 300 or a display of the computer 300 that is an output destination from the output unit 431 is described.

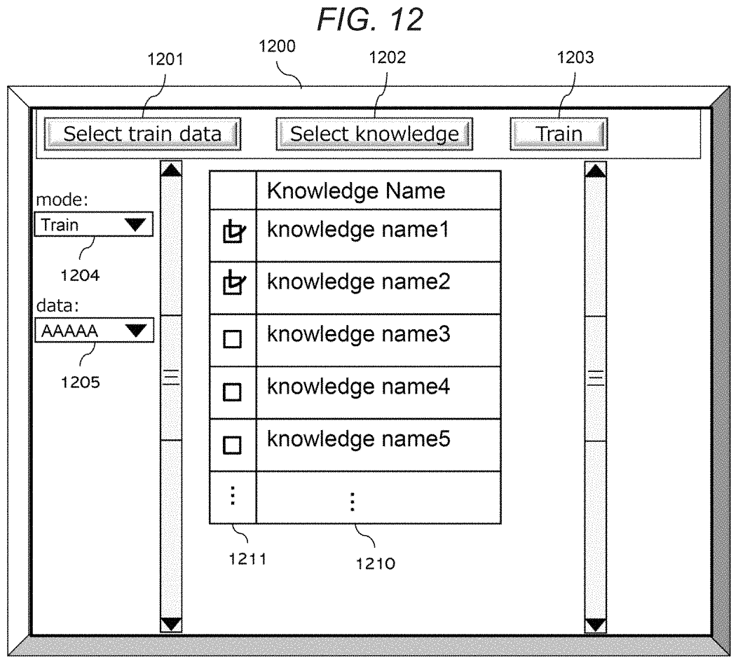

FIG. 12 is an explanatory diagram illustrating Display Example 1 of the display screen. A display screen 1200 is displayed, for example, on the displays of the bases 103 and 104.

The display screen 1200 includes a Select train data button 1201, a Select knowledge button 1202, a Train button 1203, a mode name field 1204, a data name field 1205, a selection screen 1210, and a check box 1211.

If training is desired, a user of the base 103 or 104 selects “Train” in the mode name field 1204. Subsequently, the user of the base 103 or 104 presses the Select train data button 1201 and selects the training data T3 or T4. The selected training data T3 or T4 is displayed in the data name field 1205.

Further, the user of the base 103 or 104 selects the knowledge coefficient indicating the knowledge in the past which is desired to be incorporated into the prediction model, for example, by filling in the check box 1211. The knowledge coefficient synthesis unit 503 of the base 103 or 104 synthesizes the checked knowledge coefficients I1 and I2. The synthesis knowledge coefficient Ω generated by synthesis is used for the training by a press of the Train button 1203 by the user of the base 103 or 104 (Step S1103). In addition, according to a request from the server 100, the knowledge coefficient to be selected may be presented or determined in advance.

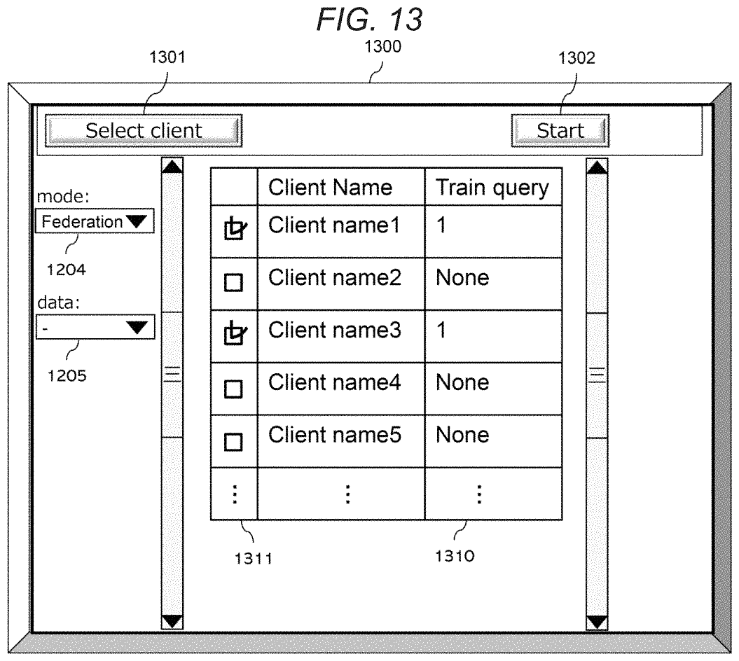

FIG. 13 is an explanatory diagram illustrating Display Example 2 of the display screen. A display screen 1300 is a screen displayed when the server 100 generates an integrated prediction model. The display screen 1300 includes a Select client button 1301, a Start button 1302, the mode name field 1204, the data name field 1205, a selection screen 1310, and a check box 1311.

If the user of the server 100 desires to generate a prediction model for integrating prediction models, the user selects Federation in the mode name field 1204. Subsequently, the user of the server 100 presses the Select client button 1301 and selects abase for generating an integrated prediction model, for example, by filling in the check box 1311.

The prediction model integration unit 411 of the server 100 integrates the prediction models from the bases with checked client names by using Expression (2) (Steps S804 and S904). In addition, in the selection screen 1310, for example, with respect to a base that makes an alert indicating that training data desired to be newly learned is collected to the server 100 or a base that transmits the newest base prediction model M0, a display such as “1” in a Train query field may be made. Thereafter, by pressing the Start button 1302, prediction models are generated and integrated to generate an integrated prediction model (Steps S804 and S904).

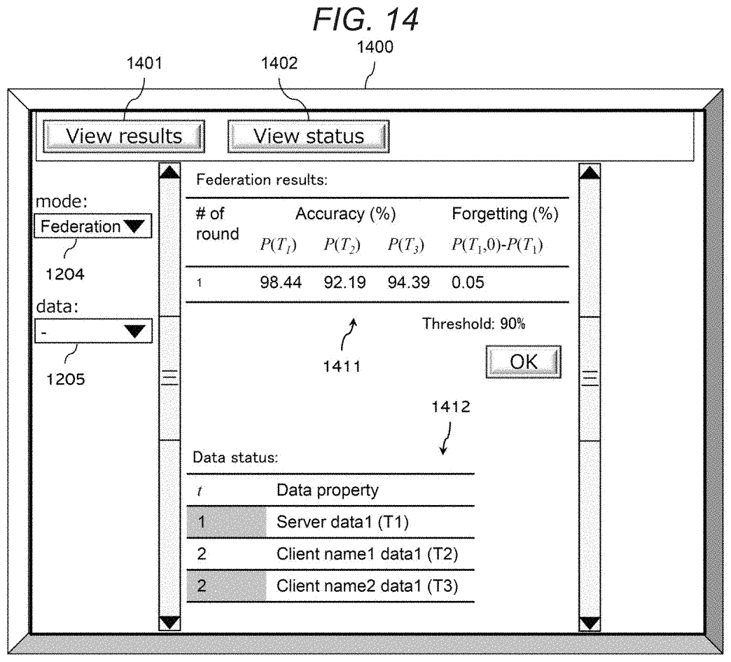

FIG. 14 is an explanatory diagram illustrating Display Example 3 of the display screen. A display screen 1400 is a screen for confirming a prediction accuracy in the server 100. Specifically, for example, the server 100 is first trained with one item of the training data T1. Thereafter, the base 101 is trained with the training data T2 by using the knowledge coefficient I1 learned with the training data T1, and the base 102 is trained with the training data T3 by using the knowledge coefficient I1 learned with the training data T1. The server 100 integrates a prediction model learned with the training data T2 by the base 101 and a prediction model learned with the training data T3 by the base 102. The display screen 1400 is a result display example when the number of times of the repetition when the integration process is performed is “1”. Specifically, the display screen 1400 is displayed in case of prediction accuracy verification (Step S907) for determining whether the prediction accuracies at the bases 101 and 102 are the threshold value or more (Step S909) in the server 100.

The display screen 1400 includes a View results button 1401, a View status button 1402, the mode name field 1204, the data name field 1205, a federated training result display screen 1411, and a data status screen 1412.

If the user of the server 100 desires to confirm the prediction accuracy of the integrated prediction model, the user selects Federation in the mode name field 1204. If the federated training process instructed in FIG. 13 ends or the prediction accuracy is verified (Step S807 and Step S907), the View results button 1401 and the View status button 1402 are displayed. If the View results button 1401 is pressed, prediction accuracies of the integrated prediction model by the respective items of the training data T1 to T3 as in the federated training result display screen 1411 are displayed.

If the View status button 1402 is pressed, at which base the respective items of the training data T1 to T3 are obtained and learned are displayed as a list as in the data status screen 1412.

As displayed on the federated training result display screen 1411, in the integrated prediction model generated by the federated learning of the prediction model learned with the training data T2 of the base 101 and the prediction model learned with the training data T3 of the base 102 by using the knowledge coefficient I1 of the training data T1 learned by the server 100 in advance, not only the prediction accuracy (P (T2)=92.19%) by the training data T2 of the base 101 and the prediction accuracy (P (T3)=94.39%) by the training data T3 of the base 102, but also the prediction accuracy (P (T1)=98.44%) by the training data T1 learned in the server 100 in advance can be kept high.

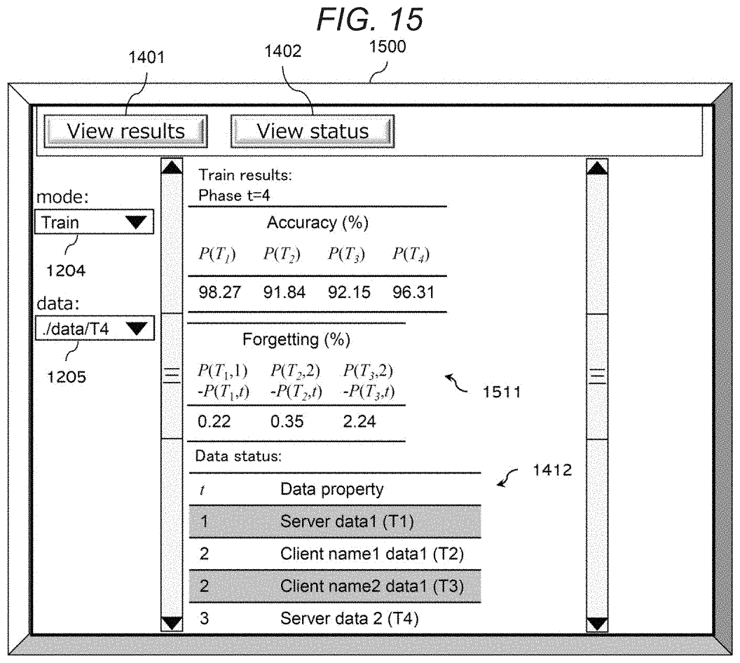

FIG. 15 is an explanatory diagram illustrating Display Example 4 of the display screen. A display screen 1500 is a screen for displaying a result relating to a prediction model in the server 100. Specifically, for example, in the same manner as in the case of FIG. 14, the server 100 is first trained with one item of the training data T1. Thereafter, the base 101 is trained with the training data T2 by using the knowledge coefficient I1 learned with the training data T1, and the base 102 is trained with the training data T3 by using the knowledge coefficient I1 learned with the training data T1. The server 100 integrates a prediction model learned with the training data T2 by the base 101 and a prediction model learned with the training data T3 by the base 102.

Further, in FIG. 15, the server 100 displays a result relating to an integrated prediction model generated by learning the new training data T4 of the server 100 with respect to the integrated prediction model by using the knowledge coefficient I1 learned with the training data T1, the knowledge coefficient I2 of the training data T2 with respect to the integrated prediction model, and the knowledge coefficient I3 of the training data T3.

The display screen 1500 includes the View results button 1401, the View status button 1402, the mode name field 1204, the data name field 1205, the training result screen 1511, and the data status screen 1412.

If the user of the server 100 desires to confirm a prediction accuracy of a prediction model, the user selects Train in the mode name field 1204. If the training process instructed in FIG. 12 ends, the View results button 1401 and the View status button 1402 are displayed.

If the View results button 1401 is pressed, the prediction accuracies by the respective items of training data by the final prediction model are displayed as in the training result screen 1511. If the View status button 1402 is pressed, as in the data status screen 1412, from which bases the respective items of training data is obtained and learned are displayed as a list.

As displayed on the training result screen 1511, an integrated prediction model generated by federated learning of a prediction model learned with the training data T2 of the base 101 and a prediction model learned with the training data T3 of the base 102 by using the knowledge coefficient I1 of the training data T1 learned in the server 100 in advance is set as the base prediction model M0.

Further, the prediction model M4 is generated by continual learning by using the base prediction model M0, the training data T4, the knowledge coefficient I1 of the training data T1, the knowledge coefficient I2 of the training data T2, and the knowledge coefficient I3 of the training data T3. In this case, it is understood that not only a prediction accuracy (P (T2)=91.84%) of the base 101 by the training data T2 and a prediction accuracy (P (T3)=92.15%) of the base 102 by the training data T3, but also a prediction accuracy (P (T1)=98.27%) by the training data T1 learned by the server 100 in advance and a prediction accuracy (P (T4)=96.31%) of the server 100 by the training data T4 learned this time can be kept high.

In Example 1, locations for generating the prediction models M1, M2, M3I, and M4I which are targets of federated learning are only the bases 101 to 104, but a prediction model generated by the server 100 may be a target of federated learning. In addition, any one of the bases 101 to 104 may play the role of the server 100.

In addition, the bases 101 to 104 may generate prediction models without using the knowledge coefficient I of the training data T in the past. In this case, the bases 101 to 104 generate prediction models by being trained by using the knowledge coefficient I at a base that generates a prediction model accepted (a prediction accuracy is a threshold value or more) in a verification result from the server 100. Then, the server 100 may integrate a prediction model generated at some limited bases among the bases 101 to 104 based on the verification results, to generate a final integrated prediction model. In addition, bases may be classified into groups in advance based on distribution characteristics of data, instead of the verification results, and an integrated prediction model for each group may be generated.

In this manner, according to an example illustrated in FIG. 15, without moving the training data T1 to T4 at the plurality of bases 101 to 104 out of the bases, by using the knowledge coefficients I1 and I2 of the plurality of items of training data T1 and T2 learned in the past, and without using the training data T1 and T2 learned in the past for retraining, the prediction model M20 that can predict the training data T1 to T4 at the plurality of bases 101 to 104 can be generated. The integrated prediction model M20I that can predict the training data T1 to T3 at the plurality of bases 101 to 103 generated by repeating the training at the respective bases 103 and 104 and the model integration at the server 100 can be generated.

With respect to the integrated prediction model M20I, if continual learning technologies are applied to the base 104, by using the training data T4 and the knowledge coefficients I1, I2, and I3 of the plurality of items of training data T1, T2, and T3 learned in the past, without using the training data T1, T2, and T3 learned in the past for the relearning, a prediction model that can predict the training data T1 to T4 at the plurality of bases 101 to 104 can be generated. Accordingly, the prediction model M20 that can predict the training data T1 to T4 at the bases 101 to 104 can be generated.

Accordingly, a reduction of time for updating prediction models due to a decrease in the training data amount, a reduction of communication amount due to a decrease in the number of bases that performs communication and the number of times of the communication, and a reduction of a usage amount of the storage device 302 that is not required to store data in the past can be realized.

In addition, in Example 1, all of the computers 300 each include the prediction model integration unit 411 and the training unit 412, and thus all of the computers 300 can be executed as the server 100 and the bases 101 to 104. In addition, the number of bases of Phase 1 is set to two in Example 1, but the number of bases of Phase 1 may be set to three or more. In the same manner, the number of bases of Phase 2 is set to two, but the number of bases of Phase 2 may be set to three or more.

In addition, after the bases 101 to 104 transmit the knowledge coefficients I1 to I4 to the server 100, the training data T1 to T4 is not required in the bases 101 to 104. Therefore, the bases 101 to 104 may delete the training data T1 to T4. Accordingly, it is possible to reduce memories of the storage devices 302 of the bases 101 to 104.

### Example 2

Example 2 is described. Example 2 is an example in which the roles of the server 100 and the bases 101 to 104 are unified to minimize the device configuration, as compared with Example 1. The server 100 does not generate a prediction model with training data. The bases 101 to 104 do not integrate prediction models. In addition, the same configurations as that of the Example 1 are denoted by the same reference numerals, and the description thereof is omitted.

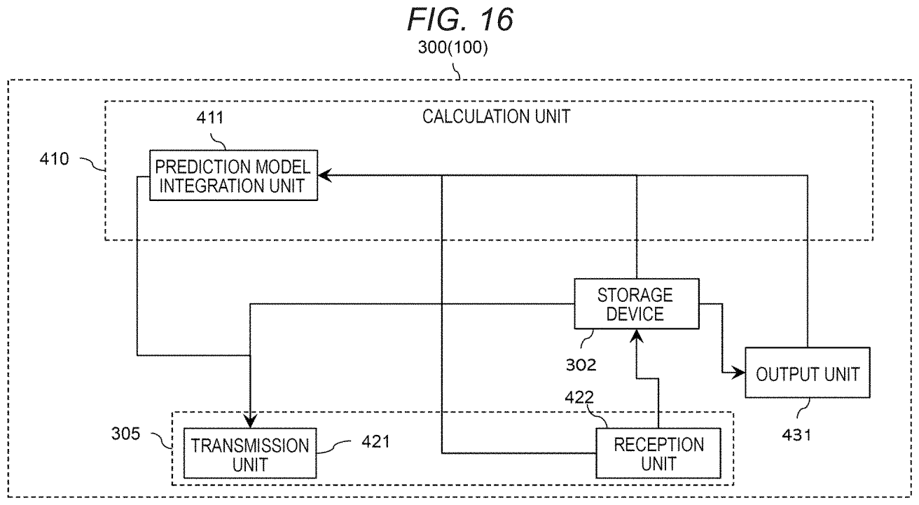

FIG. 16 is a block diagram illustrating a functional configuration example of the server 100 according to Example 2. Compared with FIG. 4, the server 100 does not include the training unit 412.

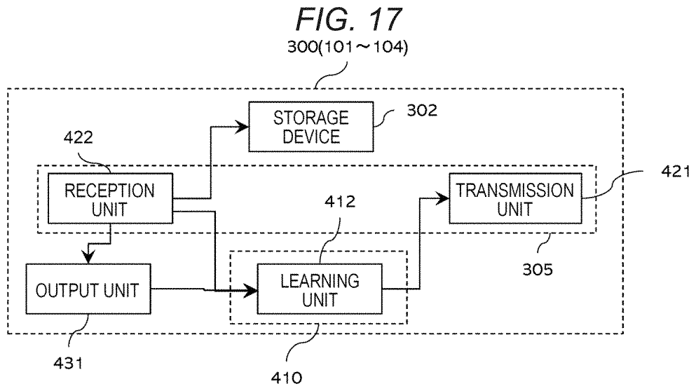

FIG. 17 is a block diagram illustrating a functional configuration example of a base according to Example 2. Compared with FIG. 4, the bases 101 to 104 do not include the prediction model integration unit 411.

Accordingly, according to Example 2, in the same manner as in Example 1, a reduction of time for updating prediction models due to a decrease in the training data amount, a reduction of communication amount due to a decrease of the number of bases that performs communication and the number of times of the communication, and a reduction of a usage amount of the storage device 302 that is not required to store data in the past can be realized.

In addition, the present invention is not limited to the above examples, and includes various modifications and similar configurations within the scope of the attached claims. For example, the examples described above are specifically described for easier understanding of the present invention, and the present invention is not necessarily limited to include all the described configurations. Further, a part of a configuration of a certain example may be replaced with a configuration of another example. In addition, a configuration of another example may be added to a configuration of one example. In addition, other configurations may be added, deleted, or replaced with respect to a part of configurations of each example.

Further, respective configurations, functions, processing unit, processing sections, and the like described above may be realized by hardware by designing a part or all thereof with, for example, an integrated circuit, or may be realized by software by interpreting and executing programs realize respective functions by a processor.

Information such as programs that realize respective functions, tables, and files can be recorded in a storage device such as a memory, a hard disk, and a solid state drive (SSD), or a recording medium such as an integrated circuit (IC) card, an SD card, a digital versatile disc (DVD).

Also, control lines and information lines that are considered necessary for description are illustrated, and not all the control lines and information lines necessary for implementation are illustrated. In practice, it may be considered that almost all configurations are interconnected.

What is claimed is:

1. An integration device comprising:
a processor that executes a program; and
a storage device that stores the program,
wherein the processor performs
a reception process of receiving a knowledge coefficient relating to first training data in a first prediction model of a first training device from the first training device,
a transmission process of transmitting the first prediction model and data relating to the knowledge coefficients of the first training data received by the reception process respectively to a plurality of second training devices, and
an integration process of generating an integrated prediction model by integrating a model parameter in a second prediction model generated by training the first prediction model with second training data and the data relating to the knowledge coefficients respectively by the plurality of second training devices, as a result of transmission in the transmission process.

2. The integration device according to claim 1, which can communicate with a plurality of the first training devices,
wherein the processor performs a precedent integration process of integrating the model parameter in the first prediction model generated by training a first training target model with the first training data by the plurality of first training devices to generate a precedent integrated prediction model,
in the reception process, the processor receives the knowledge coefficients relating to the first training data from the plurality of first training devices,
in the transmission process, the processor transmits the precedent integrated prediction model generated in the precedent integration process and the data relating to the knowledge coefficients for respective items of the first training data received by the reception process respectively to the plurality of second training devices, and
in the integration process, as a result of transmission in the transmission process, the processor integrates the model parameter in the second prediction model generated by training a second training target model with the second training data and the data relating to the knowledge coefficients respectively by the plurality of second training devices to generate the integrated prediction model.

3. The integration device according to claim 2,
wherein, in the precedent integration process, the processor repeats a process of generating the precedent integrated prediction model until prediction accuracies of the plurality of respective first prediction models are a first threshold value or more and transmitting the precedent integrated prediction model to each of the plurality of first training devices as the first training target model.

4. The integration device according to claim 2,
wherein, in the reception process, if the prediction accuracies of the plurality of respective first prediction models are a first threshold value or more, the processor receives the knowledge coefficients relating to the first training data from the plurality of respective first training devices.

5. The integration device according to claim 1,
wherein, in the transmission process, the processor transmits the first prediction model and the knowledge coefficients of the first training data to the plurality of respective second training devices.

6. The integration device according to claim 2,
wherein the processor performs a synthesis process of synthesizing the knowledge coefficients for each item of the first training data to generate a synthesis knowledge coefficient, and
in the transmission process, the processor transmits the precedent integrated prediction model and the synthesis knowledge coefficient synthesized in the synthesis process to each of the plurality of second training devices.

7. The integration device according to claim 2,
wherein, in the transmission process, the processor repeats a process of generating the integrated prediction model until prediction accuracies of the plurality of respective second prediction models are a second threshold value or more and transmitting the integrated prediction model to each of the plurality of second training devices as the second training target model.

8. A training device comprising:
a processor that executes a program; and
a storage device that stores the program,
wherein the processor performs
a training process of training a training target model with first training data to generate a first prediction model,
a first transmission process of transmitting a model parameter in the first prediction model generated by the training process to a computer,
a reception process of receiving an integrated prediction model generated by integrating the model parameter and another model parameter in another first prediction model of another training device by the computer as the training target model from the computer,
a knowledge coefficient calculation process of calculating a knowledge coefficient of the first training data if the integrated prediction model is received in the reception process, and
a second transmission process of transmitting the knowledge coefficient calculated in the knowledge coefficient calculation process to the computer.

9. The training device according to claim 8,
wherein, in the training process, the processor repeats a process of generating the first prediction model by training the integrated prediction model with the first training data until the integrated prediction model is not received in the reception process.

10. The training device according to claim 8,
wherein the processor performs a prediction accuracy calculation process of calculating a prediction accuracy of the first prediction model generated by training the integrated prediction model with the first training data in the training process, and
in the knowledge coefficient calculation process, the processor calculates the knowledge coefficient in the first prediction model if a prediction accuracy calculated in the prediction accuracy calculation process and a prediction accuracy calculated by another training device are a first threshold value or more.

11. A training device comprising:
a processor that executes a program; and
a storage device that stores the program,
wherein the processor performs
a first reception process of receiving a first prediction model and data relating to a knowledge coefficient of the first training data used for training the first prediction model from a computer,
a training process of training the first predict ion model received in the first reception process as a training target model with second training data and the data relating to the knowledge coefficient received in the first reception process to generate a second prediction model, and
a transmission process of transmitting a model parameter in the second prediction model generated in the training process to the computer.

12. The training device according to claim 11,
wherein the processor performs a second reception process of receiving a second integrated prediction model generated by integrating the model parameter in the second prediction model and another model parameter in another second prediction model trained by another training device by the computer as the training target model, from the computer, and
in the training process, the processor repeats a process of generating the second prediction model until the second integrated prediction model is not received in the second reception process from the computer.

13. The training device according to claim 11,
wherein the processor performs
a second reception process of receiving a second integrated prediction model generated by integrating the model parameter in the second prediction model and another model parameter in another second prediction model trained by another training device by the computer, as the training target model, from the computer, and
a prediction accuracy calculation process of calculating a prediction accuracy of the second prediction model generated by training the second integrated prediction model received in the second reception process with the second training data and data relating to the knowledge coefficient in the training process, and
in the training process, the processor repeats a process of generating the second prediction model until the prediction accuracy calculated in the prediction accuracy calculation process and a prediction accuracy calculated by the other training device are a second threshold value or more.

14. The training device according to claim 11,
wherein, in the first reception process, the processor receives a first integrated prediction model obtained by integrating the plurality of first prediction models and data relating to the knowledge coefficient for each item of the first training data used for training the respective first prediction models from the computer,
the processor performs a synthesis process of synthesizing the knowledge coefficient for each item of the first training data to generate a synthesis knowledge coefficient, and
in the training process, the processor generates the second prediction model by training the training target model with the second training data and the synthesis knowledge coefficient generated in the synthesis process.

15. An integration method performed by an integration device including a processor that executes a program, and a storage device that stores the program,
wherein the processor performs
a reception process of receiving a knowledge coefficient relating to first training data in a first prediction model of a first training device from the first training device,
a transmission process of transmitting the first prediction model and data relating to the knowledge coefficients of the first training data received in the reception process respectively to a plurality of second training devices, and
an integration process of generating an integrated prediction model by integrating a model parameter in a second prediction model generated by training the first prediction model with second training data and the data relating to the knowledge coefficients respectively by the plurality of second training devices, as a result of transmission by the transmission process.
